(19) United States
(12) Patent Application Publication
(10) Pub. No.: US 2009/0020607 A1
(43) Pub. Date: Jan. 22, 2009

(54) Method for Device Activation

(76) Inventor: Dilshan Perera, Rajagiriya (LK)

Correspondence Address: Fay Kaplun & Marcin, LLP/ Motorola, 150 Broadway Suite 702, New York, NY, 10038, US

(21) Appl. No.: 11/778,781

(22) Filed: Jul. 17, 2007

(51) Int. Cl. G06K 7/016

(52) U.S. Cl. 235/440

(57) ABSTRACT

Described is a method including the steps of receiving one of a first input and a second input and enabling a functionality corresponding to the one of the received first and the second input. The method further includes the steps of starting a timer upon receipt of the one of the first input and the second input, determining if one of a predetermined action of the functionality has occurred and the timer has reached a predetermined value, and disabling the functionality when the one of the predetermined action occurring and the timer reaching the predetermined value has been determined.

### FIELD OF INVENTION

The present application generally relates to methods for device activation and deactivation.

### BACKGROUND INFORMATION

Electronic devices often include multiple functions that are activated via a trigger arrangement, such as a pushbutton or switch. In some devices, the same trigger arrangement is used to activate multiple functions. This may lead to user confusion if two or more functions are simultaneously activated when the trigger arrangement is engaged.

### SUMMARY OF THE INVENTION

The present invention relates to a method including the steps of receiving one of a first input and a second input and enabling a functionality corresponding to the one of the received first and the second input. The method further includes the steps of starting a timer upon receipt of the one of the first input and the second input, determining if one of a predetermined action of the functionality has occurred and the timer has reached a predetermined value, and disabling the functionality when the one of the predetermined action occurring and the timer reaching the predetermined value has been determined.

The present invention also relates to a method including the steps of receiving one of a first input and a second input, enabling a functionality corresponding to the one of the received first and second input, and starting a timer upon receipt of the one of the first input and the second input. The method also includes the steps of detecting, after the receipt of the one of the first input and the second input, when the receipt of the one of the first and second inputs is interrupted and disabling the functionality when the interruption of the user input has been detected. The method further includes the steps of determining, when the receipt of the one of the first and second inputs has not been detected, if one of a predetermined action of the functionality has occurred and the timer has reached a predetermined value, and disabling the functionality when the one of the predetermined action occurring and the timer reaching the predetermined value has been determined.

The present invention also relates to a device including an input arrangement receiving one of a first input and a second input, first and second function modules, and a timer. The timer is started upon receipt of the one of the first input and the second input, the first module is enabled in response to the receiving of the first input, and the second module is enabled in response to the receiving of the second input. The device determines if one of a predetermined action of the enabled module has occurred and the timer has reached a predetermined value, and the device also disables the enabled module when the one of the predetermined action occurring and the timer reaching the predetermined value has been determined.

The present invention also relates to a device including an input arrangement receiving one of a first input and a second input, first and second function modules, and a timer. The first module is enabled in response to the receiving of the first input, the second module is enabled in response to the receiving of the second input, and the device starts the timer upon receipt of the one of the first input and the second input. The device detects, after the receipt of the one of the first input and the second input, when the receipt of the one of the first and second inputs is interrupted. The device disables the enabled module when the interruption of the user input has been detected. The device determines, when the receipt of the one of the first and second inputs has not been detected, if one of a predetermined action of the enabled module has occurred and the timer has reached a predetermined value. The device also disables the enabled module when the one of the predetermined action occurring and the timer reaching the predetermined value has been determined.

The present invention also relates to a device including an input means receiving one of a first input and a second input, first and second function means, each function means enabling a functionality of the device, and a timing means. The timing means is started upon receipt of the one of the first input and the second input, the first function means is enabled in response to the receiving of the first input, the second function means is enabled in response to the receiving of the second input. The device determines if one of a predetermined action of the enabled function means has occurred and the timing means has reached a predetermined value. The device also disables the enabled function means when the one of the predetermined action occurring and the timing means reaching the predetermined value has been determined.

### BRIEF DESCRIPTION OF THE DRAWINGS

FIG. 1 shows a block diagram of a device according to the present invention.

FIG. 2 shows a method according to the present invention.

FIG. 3 shows another method according to the present invention.

### DETAILED DESCRIPTION

The present invention may be further understood with reference to the following description and the appended drawings, wherein like elements are provided with the same reference numerals. The present invention relates to methods for activating (e.g., triggering a function of) a device. Various embodiments of the present invention will be described with reference to a mobile device comprising a radio-frequency identification (“RFID”) reader and a bar code scanner. However, those skilled in the art will understand that the present invention may be implemented with any electronic device which has a plurality of functions. For example, the electronic device may be a mobile or portable device such as a laptop, a cell phone, a personal digital assistant, a global positioning system handheld, etc. The electronic device may also be a stationary device such as a desktop computer, a television, a telephone, etc.

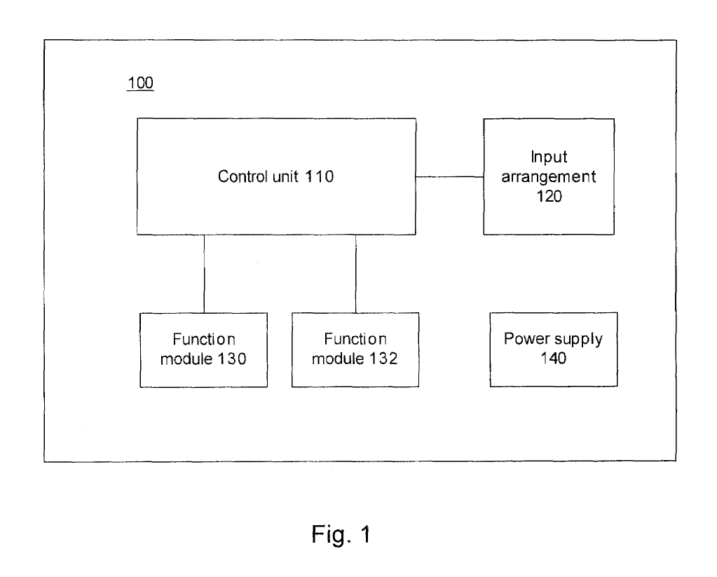

FIG. 1 shows a block diagram of an exemplary embodiment of a device 100 according to the present invention. The device 100 may be used to implement any of the methods for device activation that will be described below. As shown in FIG. 1, the device 100 may include a control unit 110, an input arrangement 120, function modules 130 and 132, and a power supply 140. The device 100 may be a mobile device with a plurality of functions (e.g., the function modules 130, 132). The function modules 130, 132 may each provide a different function. For example, as will be described below, the function module 130 may correspond to a bar code scanning function and the function module 132 may correspond to an RFID reading function.

The control module 110 may be a microprocessor, an embedded controller, an application-specific integrated circuit, or any other circuit or combination of circuits that control operation of the device 100. The control module 110 may, for example, include a digital counter or timing circuit that is capable of keeping track of elapsed time. The counter may be implemented in any combination of hardware and/or software including integrated circuits and analog RC circuits. Although the exemplary embodiment described includes an integrated counter, other embodiments may utilize counters that are separately coupled to the control module 110.

The input arrangement 120 may be any mechanism by which a user can input a selection or indicate a desire to activate a function of the device 100. In one embodiment, the input arrangement 120 may be a mechanical trigger (e.g., a gun-style trigger) that is manually engaged by the user. Other embodiments may utilize other types of input arrangements such as keypad buttons, push buttons, slide switches, proximity sensors, touch screens, etc. The input arrangement 120 may produce an output signal (e.g., an output voltage) when engaged. Continued engaging may cause the input arrangement 120 to continue producing the output signal (e.g., a continuous voltage).

The function modules 130, 132 may be any combination of hardware and/or software that performs a device function. For example, the module 130 may comprise a bar code scanning arrangement including a bar code imager (e.g., a laser), an optical sensor (e.g., a photodetector), signal processing circuitry, etc. The module 132 may comprise an RFID arrangement including a wireless transceiver, signal processing circuitry, etc. The function modules 130, 132 need not be related or serve similar functions (e.g., data acquisition). Rather, in other embodiments the function modules 130, 132 may perform any number of diverse functions, such as audio or visual presentation, data processing, wireless communication, mechanical work, etc. In addition, the function modules 130, 132 may be integral (i.e., comprising portions of the same module) in some embodiments.

The power supply 140 may comprise any number of power delivery arrangements. In one embodiment, the power supply 140 may be a rechargeable battery (e.g., a lithium-ion battery). In another embodiment, the power supply 140 may be a non-rechargeable battery. In still further embodiments, the power supply 140 may be adapted to receive power from an external source (e.g., solar energy, an AC outlet, another backup generator, etc.). The power supply 140 may provide electrical power to each of the components of the device 100, including the function modules 130, 132.

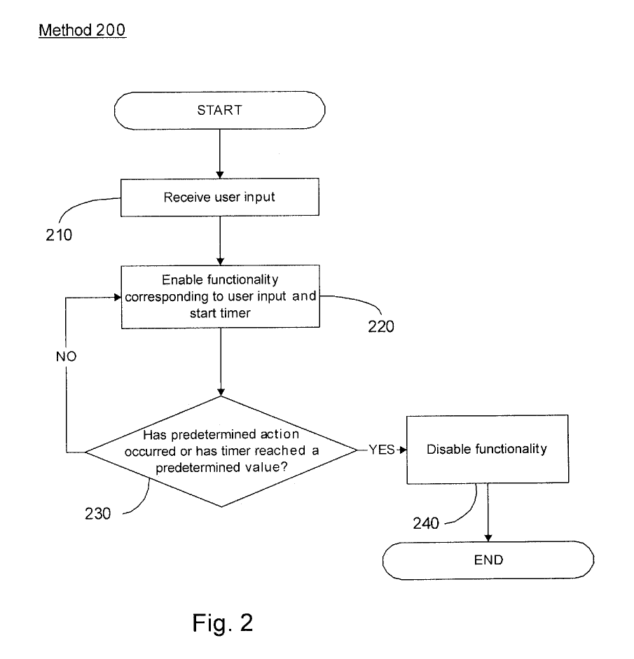

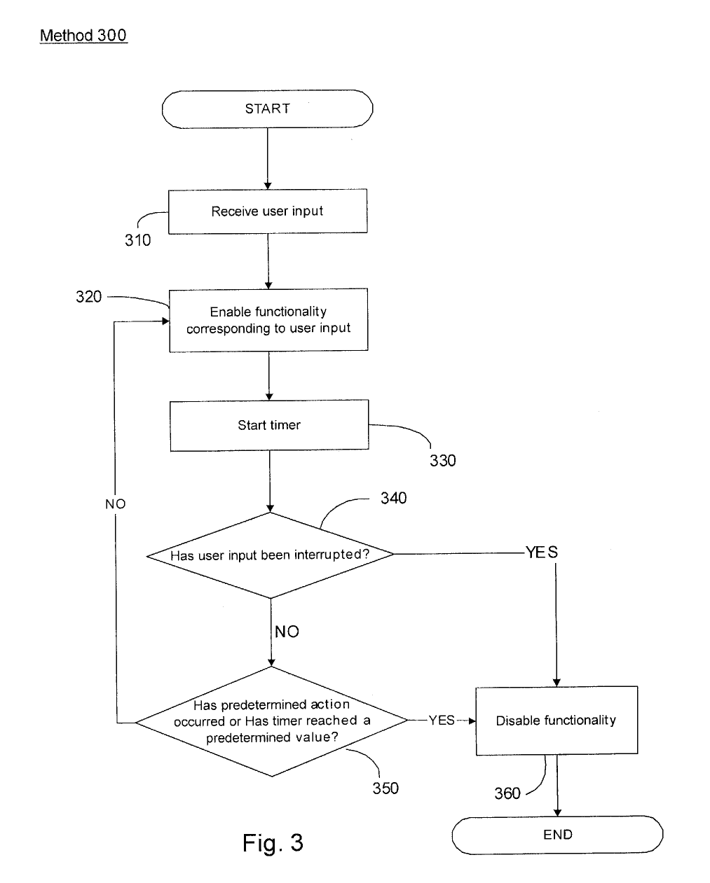

Exemplary embodiments of methods for triggering a device will now be described with reference to FIGS. 2 and 3. FIG. 2 shows a method involving an enabling of a device function in response to single and multiple engagings of an input arrangement, where the engaging may be discrete (e.g., non-continuous and/or finite in duration). FIG. 3 shows a second method involving an enabling of a device function in response to single and multiple engagings of an input arrangement, where the enabling may be conditioned on continuous engaging. The methods of FIGS. 2 and 3 will be described with reference to the device 100. However, those skilled in the art will understand that the methods described may also be implemented in other devices.

FIG. 2 shows an exemplary embodiment of a method 200 according to the present invention. The method 200 may be implemented on the device 100 and describes a procedure in which a function of the device 100 is activated. In step 210, the device 100 receives user input via the input arrangement 120. As described above, the input may comprise an engaging of the manual trigger. The device 100 detects the output signal of the input arrangement 200 and recognizes this as an indication of the user's desire to activate a device function. The function modules 130, 132 may each correspond to a different type of engaging of the input arrangement 120. For example, engaging the input arrangement 120 once may correspond to the module 130, while engaging the input arrangement 120 twice may correspond to the module 132. Multiple engagings may be separated by a predetermined maximum duration beyond which a subsequent engaging may be considered a single engaging rather than coupled to a previous engaging. Engaging in accordance with the method 200 may comprise discrete engaging of the input arrangement 120. That is, the single engaging may be an engaging of finite duration, which is not completed until the input arrangement 120 is disengaged.

A single engaging of the input arrangement 120 may comprise a continuous output signal of predetermined duration or, alternatively, a specific output signal of predetermined pattern. Multiple engaging of the input arrangement 120 may comprise the continuous output signal followed by an interruption and a resuming of the continuous output signal. Alternatively, the multiple engaging may comprise multiple instances of the specific output signal having the predetermined pattern.

In step 220, the device 100 enables the function that corresponds to the user input. If, for example, the user input is the single engaging, then the module 130 may be enabled to allow the user to scan a bar code. If, however, the user input is the double engaging, then the module 132 may be enabled for detection of nearby RFID tags. In step 220, the device 100 also starts a timer (e.g., the digital counter or timing circuit). The timer may be configured to start as soon as the user input has been received. Each time the user input is received, the timer may be reset to a predetermined initial value (e.g., zero).

In step 230, the device 100 determines whether a predetermined action has occurred during a predetermined time period. That is, the device 100 detects whether the timer has reached a predetermined value and whether the predetermined action has occurred prior to reaching the predetermined value. The predetermined action may vary depending on a nature of the function enabled. For example, if the module 130 is enabled, the predetermined action may be a valid (i.e., successful) scanning of a bar code. If the module 132 is enabled, the predetermined action may be a detection of a nearby RFID tag and/or a successful transfer of data between the device 100 and the tag. Thus, the predetermined action may include intentional user actions (e.g., placing a bar code in front of the bar code imager) in addition to unintentional actions (e.g. a random encounter with an RFID tag).

If either of the two conditions detected in step 230 (i.e., the occurrence of the predetermined action or the reaching of the predetermined time value) has occurred, the device 100 disables the functionality that was previously enabled (step 240). However, if neither of the two conditions has occurred, then the device 100 continues to enable the function by returning to step 220. In step 220, the timer continues to run and the method 200 alternates between the steps 220 and 230 until one of the two conditions is met.

FIG. 3 shows a second exemplary embodiment of a method 300 according to the present invention. The method 300 may be implemented on the device 100 and describes a procedure in which a functionality of the device 100 is activated. In step 310, the device 100 receives user input via the input arrangement 120. The user input may be a single engaging or a multiple engaging of the input arrangement 120. However, engaging in accordance with the method 300 may be continuous rather than discrete. That is, the engaging may be considered complete as soon as the engaging begins or after a predetermined period of continuous engaging.

In step 320, the device 100 enables the function that corresponds to the user input. As described above with reference to the method 200, the module 130 may be enabled based on the single engaging and the module 132 may be enabled based on the double engaging.

In step 330, the device 100 starts the timer. The timer may begin counting from the predetermined initial value. That is, the timer may be reset to the initial value each time it is started. In another embodiment, the timer may not be reset and time may be tracked beginning at any arbitrary starting value.

In step 340, the device 100 determines whether the user input has been interrupted. For example, the device 100 may detect a break or discontinuity in the output signal. This may be performed by, for example, determining whether a predetermined amount of time has elapsed since a most recent detection of the output signal. If the interruption of the user input has been determined, the method 300 proceeds to step 360, where the previously enabled function is disabled.

In step 350, the interruption of the user input has not been determined and the device 100 determines whether a predetermined action has occurred during a predetermined time period. This may be performed in a manner substantially similar to step 230 of the method 200, where the device 100 makes separate determinations of whether the predetermined action has occurred and whether the timer has reached the predetermined value. As discussed above, the predetermined action may include intentional user actions, such as placing a bar code in front of the bar code imager, in addition to unintentional actions, such as a random encounter with an RFID tag. If the predetermined action has not occurred and the predetermined value has not been reached, the method 300 returns to step 320, where the function continues to be enabled. However, if either the predetermined action has occurred or the timer has reached the predetermined value, the method 300 proceeds to step 360.

In step 360, either the predetermined action has occurred, the timer has reached the predetermined value, or the user input has been interrupted. The device 100 disables the function that was previously enabled and the method 300 is complete.

In addition to enabling functions that are normally disabled, the methods 200 and 300 may also be utilized for disabling functions that are normally enabled. Thus, in other embodiments, the steps 220 and 320 may be modified by disabling rather than enabling the functionality after the user input is received.

The exemplary embodiments of the present invention described above may enable an improved user experience by decreasing user confusion regarding what functions are currently enabled. Because each function may be activated using a different engaging of the input arrangement 120, the user does not become confused regarding whether both the function modules 130, 132 are activated. Instead, the user is able to select one function to activate while being assured that other functions are not simultaneously activated.

In addition, the exemplary embodiments of the present invention may enable for reduced operating cost. Because different functions may be separately activated, power usage is reduced as a result of not having to operate both function modules 130, 132 simultaneously. Thus, usage of the power supply 140 may be optimized under the exemplary embodiments described above.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A method, comprising:
receiving one of a first input and a second input;
enabling a functionality corresponding to the one of the received first and the second input;
starting a timer upon receipt of the one of the first input and the second input;
determining if one of a predetermined action of the functionality has occurred and the timer has reached a predetermined value; and
disabling the functionality when the one of the predetermined action occurring and the timer reaching the predetermined value has been determined.

2. The method according to claim 1, wherein the first input is a first engaging of an input arrangement and the second input is a second engaging of the input arrangement.

3. The method according to claim 2, wherein the second engaging occurs within a predetermined period of time after the first engaging.

4. The method according to claim 1, wherein the functionality corresponding to the first input is one of a bar code scanning function and an RFID reading function.

5. The method according to claim 4, wherein the functionality corresponding to the second input is the other one of the bar code scanning function and the RFID reading function.

6. A method, comprising:
receiving one of a first input and a second input;
enabling a functionality corresponding to the one of the received first and second input;
starting a timer upon receipt of the one of the first input and the second input;
detecting, after the receipt of the one of the first input and the second input, when the receipt of the one of the first and second inputs is interrupted;
disabling the functionality when the interruption of the user input has been detected;
determining, when the receipt of the one of the first and second inputs has not been detected, if one of a predetermined action of the functionality has occurred and the timer has reached a predetermined value; and
disabling the functionality when the one of the predetermined action occurring and the timer reaching the predetermined value has been determined.

7. The method according to claim 6, wherein the first input is a first engaging of an input arrangement and the second input is a second engaging of the input arrangement.

8. The method according to claim 7, wherein the second engaging occurs within a predetermined period of time after the first engaging.

9. The method according to claim 6, wherein the functionality corresponding to the first input is one of a bar code scanning function and an RFID reading function.

10. The method according to claim 9, wherein the functionality corresponding to the second input is the other one of the bar code scanning function and the RFID reading function.

11. A device, comprising:
an input arrangement receiving one of a first input and a second input;
first and second function modules; and
a timer;
wherein the timer is started upon receipt of the one of the first input and the second input, the first module is enabled in response to the receiving of the first input, the second module is enabled in response to the receiving of the second input,
wherein the device determines if one of a predetermined action of the enabled module has occurred and the timer has reached a predetermined value, and
wherein the device disables the enabled module when the one of the predetermined action occurring and the timer reaching the predetermined value has been determined.

12. The device according to claim 11, wherein the first input is a first engaging of an input arrangement and the second input is a second engaging of the input arrangement.

13. The device according to claim 12, wherein the second engaging must occur within a predetermined period of time after the first engaging.

14. The device according to claim 11, wherein the first module provides one of a bar code scanning function and an RFID reading function.

15. The device according to claim 14, wherein the second module provides the other one of the bar code scanning function and the RFID reading function.

16. A device, comprising:
an input arrangement receiving one of a first input and a second input;
first and second function modules; and
a timer;
wherein the first module is enabled in response to the receiving of the first input, the second module is enabled in response to the receiving of the second input,
wherein the device starts the timer upon receipt of the one of the first input and the second input,
wherein the device detects, after the receipt of the one of the first input and the second input, when the receipt of the one of the first and second inputs is interrupted,
wherein the device disables the enabled module when the interruption of the user input has been detected,
wherein the device determines, when the receipt of the one of the first and second inputs has not been detected, if one of a predetermined action of the enabled module has occurred and the timer has reached a predetermined value, and
wherein the device disables the enabled module when the one of the predetermined action occurring and the timer reaching the predetermined value has been determined.

17. The device according to claim 16, wherein the first input is a first engaging of an input arrangement and the second input is a second engaging of the input arrangement.

18. The device according to claim 17, wherein the second engaging must occur within a predetermined period of time after the first engaging.

19. The device according to claim 16, wherein the first module provides one of a bar code scanning function and an RFID reading function.

20. The device according to claim 19, wherein the second module provides the other one of the bar code scanning function and the RFID reading function.

21. A device, comprising:
an input means receiving one of a first input and a second input;
first and second function means, each function means enabling a functionality of the device; and
a timing means;
wherein the timing means is started upon receipt of the one of the first input and the second input, the first function means is enabled in response to the receiving of the first input, the second function means is enabled in response to the receiving of the second input,
wherein the device determines if one of a predetermined action of the enabled function means has occurred and the timing means has reached a predetermined value, and
wherein the device disables the enabled function means when the one of the predetermined action occurring and the timing means reaching the predetermined value has been determined.
